(19) United States
(12) Patent Application Publication
(10) Pub. No.: US 2024/0083112 A1
(43) Pub. Date: Mar. 14, 2024

(54) THREE-DIMENSIONAL OBJECT PRINTING APPARATUS AND CONTROL METHOD

(71) Applicant: SEIKO EPSON CORPORATION, Tokyo (JP)

(72) Inventors: Shinichi NAKAMURA, OKAYA-SHI (JP); Keigo SUGAI, CHINO-SHI (JP); Hajime KOBAYASHI, CHINO-SHI (JP)

(21) Appl. No.: 18/461,771

(22) Filed: Sep. 6, 2023

(30) Foreign Application Priority Data
Sep. 8, 2022 (JP) 2022-142837

(51) Int. Cl. B29C 64/236; B29C 64/209; B29C 64/232; B29C 64/264; B29C 64/393

(52) U.S. Cl. CPC B29C 64/236; B29C 64/209; B29C 64/232; B29C 64/264; B29C 64/393; B33Y 30/00

(57) ABSTRACT

A three-dimensional object printing apparatus includes: a head unit including a head that ejects a liquid toward a three-dimensional workpiece along a Z axis; a sensor unit including a sensor that detects a positional relationship with respect to the workpiece; and a movement mechanism that change positions of the head unit and the sensor unit with respect to the workpiece, in which the movement mechanism includes a first Z-axis movement mechanism that changes the position of the sensor unit with respect to the workpiece along the Z axis, and a second Z-axis movement mechanism that changes the position of the head unit with respect to the workpiece along the Z axis, and the first Z-axis movement mechanism and the second Z-axis movement mechanism move the sensor unit and the head unit independently of each other.

The present application is based on, and claims priority from JP Application Serial Number 2022-142837, filed Sep. 8, 2022, the disclosure of which is hereby incorporated by reference herein in its entirety.

### BACKGROUND

### 1. Technical Field

The present disclosure relates to a three-dimensional object printing apparatus and a control method.

### 2. Related Art

Hitherto, there is known a three-dimensional object printing apparatus that performs printing on a surface of a three-dimensional workpiece by using an ink jet method. For example, an apparatus described in JP-A-2012-035552 includes an ink jet head, a unit that relatively moves a target object and the ink jet head in an X direction and a Y direction, a unit that measures a position of the ink jet head, a unit that measures an interval between the target object and the ink jet head, and a mechanism that moves the ink jet head up and down based on the position measurement result and the interval measurement result.

However, in the apparatus described in JP-A-2012-035552, there is a possibility that the ink jet head collides with the target object during printing when an error occurs in measuring the interval between the target object and the ink jet head or when an installation position of the target object is misaligned.

### SUMMARY

According to an aspect of the present disclosure, a three-dimensional object printing apparatus includes: a head unit including a head that ejects a liquid toward a workpiece along a first axis; a sensor unit including a sensor that detects a positional relationship with respect to the workpiece; and a movement mechanism that changes positions of the head unit and the sensor unit with respect to the workpiece, in which the movement mechanism includes a first movement mechanism that changes the position of the sensor unit with respect to the workpiece along the first axis, and a second movement mechanism that changes the position of the head unit with respect to the workpiece along the first axis, and the first movement mechanism and the second movement mechanism move the sensor unit and the head unit independently of each other.

According to an aspect of the present disclosure, a control method for controlling the three-dimensional object printing apparatus including a head unit including a head that ejects a liquid toward a workpiece along a first axis, a sensor unit including a sensor that detects a positional relationship with respect to the workpiece, a first movement mechanism that changes a position of the sensor unit with respect to the workpiece along the first axis, and a second movement mechanism that changes a position of the head unit with respect to the workpiece along the first axis includes: moving, by the first movement mechanism and the second movement mechanism, the sensor unit and the head unit independently of each other.

### BRIEF DESCRIPTION OF THE DRAWINGS

FIG. 1 is a schematic perspective view illustrating a three-dimensional object printing apparatus according to a first embodiment.

FIG. 2 is a block diagram illustrating an electrical configuration of the three-dimensional object printing apparatus according to the first embodiment.

FIG. 3 is a perspective view illustrating schematic configurations of a head unit and adjustment mechanisms.

FIG. 4 is a perspective view illustrating schematic configurations of a sensor unit and the adjustment mechanisms.

FIG. 5 is a diagram for describing a distal end region of contact sensors.

FIG. 6 is a diagram illustrating an example of an operation of the three-dimensional object printing apparatus according to the first embodiment.

FIG. 7 is a diagram for describing a first confirmation operation in a confirmation operation.

FIG. 8 is a diagram for describing a second confirmation operation in the confirmation operation.

FIG. 9 is a diagram for describing a printing operation.

FIG. 10 is a diagram for describing a curing operation.

FIG. 11 is a diagram for describing a confirmation operation according to a second embodiment.

FIG. 12 is a diagram for describing a confirmation operation according to a third embodiment.

FIG. 13 is a diagram for describing a printing operation according to the third embodiment.

### DESCRIPTION OF EMBODIMENTS

Hereinafter, exemplary embodiments according to the present disclosure will be described with reference to the accompanying drawings. Note that the dimensions and the scale of each component may differ appropriately from actual dimensions and scale, and some portions are schematically illustrated in the drawings to facilitate understanding. Further, the scope of the present disclosure is not limited to the embodiments unless otherwise specified in the following description.

In the following description, an X axis, a Y axis, and a Z axis that intersect one another are appropriately used for the sake of convenience. Further, in the following description, a direction along the X axis is referred to as an X1 direction, and a direction opposite to the X1 direction is referred to as an X2 direction. Similarly, directions opposite to each other along the Y axis are a Y1 direction and a Y2 direction. Further, directions opposite to each other along the Z axis are a Z1 direction and a Z2 direction.

Here, the X axis, the Y axis, and the Z axis are coordinate axes of a world coordinate system set in a space in which movement mechanisms 2 and a support mechanism 4 to be described later are installed. Typically, the Z axis is a vertical axis, and the Z2 direction corresponds to a downward direction along the vertical axis. Hereinafter, a case of controlling operations of the movement mechanism 2 by using the world coordinate system will be described as an example for the sake of convenience.

Note that the Z axis does not have to be a vertical axis. Typically, the X axis, the Y axis, and the Z axis are orthogonal to one another. However, the X axis, the Y axis, and the Z axis are not limited thereto, and do not have to be orthogonal to one another. For example, it is sufficient that the X axis, the Y axis, and the Z axis intersect one another within an angle range of 80° to 100°.

### 1. FIRST EMBODIMENT

### 1-1. Overview of Three-dimensional Object Printing Apparatus

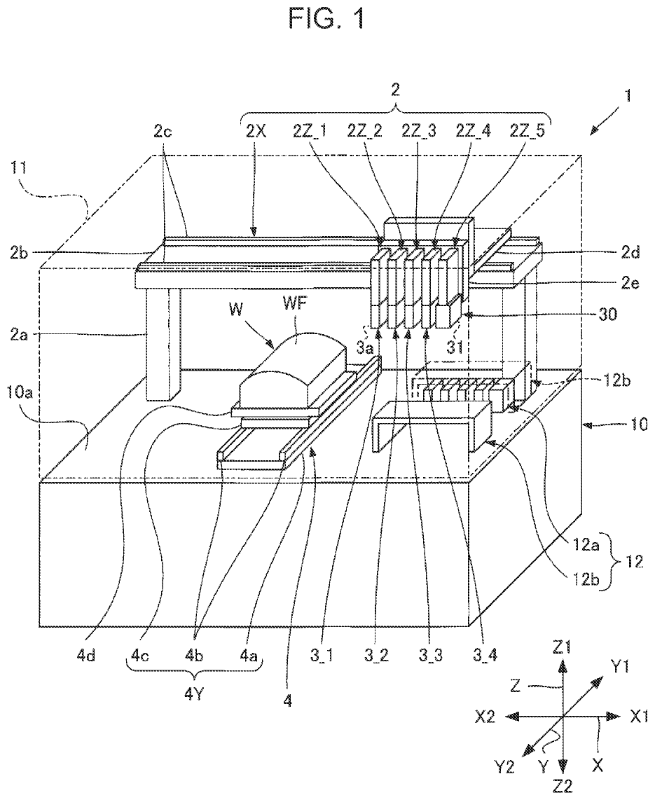

FIG. 1 is a schematic perspective view illustrating a three-dimensional object printing apparatus 1 according to a first embodiment. The three-dimensional object printing apparatus 1 is an apparatus that performs printing on a surface of a three-dimensional workpiece W by using an ink jet method.

The workpiece W has a surface WF to be subjected to printing. In the example illustrated in FIG. 1, the surface WF is a convex curved surface having a plurality of portions with different curvatures. A surface other than the surface WF among a plurality of surfaces of the workpiece W may be subjected to printing. Moreover, the size, shape, and installation posture of the workpiece W are not limited to those in the example illustrated in FIG. 1, and may be arbitrary.

As illustrated in FIG. 1, the three-dimensional object printing apparatus 1 includes a base 10, the movement mechanism 2, head units 3_1 to 3_4, a sensor unit 30, the support mechanism 4, and a maintenance mechanism 12. Hereinafter, the respective parts of the three-dimensional object printing apparatus 1 will be schematically described sequentially with reference to FIG. 1. Hereinafter, each of the head units 3_1 to 3_4 may be referred to as a head unit 3.

The base 10 is a table having a surface 10a that supports the movement mechanism 2, the support mechanism 4, and the maintenance mechanism 12. The surface 10a is a surface directed toward the Z1 direction. Here, each of the movement mechanism 2, the support mechanism 4, and the maintenance mechanism 12 is fixed to the base 10 directly by screws or the like, or indirectly via other members.

In the example illustrated in FIG. 1, the base 10 has a box shape, and the surface 10a is directed toward the Z1 direction. Although not illustrated in detail, a case 11 is disposed at a position in the Z1 direction with respect to the base 10, as indicated by a line with alternating long and two short dashes in FIG. 1. The case 11 is a box-shaped structure forming a space between the case 11 and the surface 10a to accommodate the structures such as the movement mechanism 2, the support mechanism 4, and the maintenance mechanism 12 supported on the base 10. For example, the case 11 has a plurality of pillars, a plurality of beams, and a plurality of plate members such as a top plate and wall plates, the plurality of pillars and the plurality of beams being formed of metal or the like, and the plurality of plate members being formed of a transparent material such as an acrylic resin. Although not illustrated, the case 11 is provided with a door for supplying and removing the workpiece W to and from the support mechanism 4 and a window for viewing the maintenance mechanism 12 from the outside of the case 11.

The configuration of the base 10 is not limited to the example illustrated in FIG. 1, and may be arbitrary. Further, it is sufficient if each of the base 10 and the case 11 is provided as necessary, or the base 10 and the case 11 may be omitted. When the base 10 is omitted, each component of the three-dimensional object printing apparatus 1 is installed, for example, on the floor, wall, ceiling, or the like of a building. In other words, the base 10 does not have to be a component of the three-dimensional object printing apparatus 1, and may be the floor, wall, ceiling, or the like of a building, for example. In the present embodiment, the movement mechanism 2, the support mechanism 4, and the maintenance mechanism 12 are supported on the same planar surface 10a, but the movement mechanism 2, the support mechanism 4, and the maintenance mechanism 12 may be supported on surfaces directed toward different directions. For example, the movement mechanism 2 may be installed on one of the floor, the wall, and the ceiling, and the support mechanism 4 may be installed on the other one of the floor, the wall, and the ceiling. Further, the movement mechanism 2 may be installed on one of a plurality of walls directed toward different directions, and the support mechanism 4 may be installed on another one of the plurality of walls.

The movement mechanism 2 has mechanisms that change the relative positions of the head units 3_1 to 3_4 and the sensor unit 30 with respect to the workpiece W.

In the example illustrated in FIG. 1, the movement mechanism 2 changes the relative positions of the head units 3_1 to 3_4 and the sensor unit 30 with respect to the workpiece W in directions along the X axis and the Z axis. The movement mechanism 2 includes an X-axis movement mechanism 2X and Z-axis movement mechanisms 2Z_1 to 2Z_5. Here, each of the Z-axis movement mechanisms 2Z_1 to 2Z_4 is an example of a “first movement mechanism”, and the Z-axis movement mechanism 2Z_5 is an example of a “second movement mechanism”. Hereinafter, each of the Z-axis movement mechanisms 2Z_1 to 2Z_5 may be referred to as the Z-axis movement mechanism 2Z.

The X-axis movement mechanism 2X is a linear movement mechanism that changes the relative position of each of the head units 3 and the sensor unit 30 with respect to the workpiece W along the X axis orthogonal to the Z axis. In the example illustrated in FIG. 1, the X-axis movement mechanism 2X supports the head units 3_1 to 3_4 and the sensor unit 30 via the Z-axis movement mechanisms 2Z_1 to 2Z_5, and moves the head units 3_1 to 3_4 and the sensor unit 30 in the direction along the X axis.

The X-axis movement mechanism 2X includes a pair of pillars 2a, a beam 2b, a pair of rails 2c, and a movable body 2d. The pair of pillars 2a, the beam 2b, the pair of rails 2c, and the movable body 2d are formed of metal such as iron, stainless steel, or an aluminum alloy.

Each of the pair of pillars 2a is a member extending from the surface 10a of the base 10 in the Z1 direction. In the example illustrated in FIG. 1, the pair of pillars 2a is arranged in the direction along the X axis. The beam 2b spans over distal ends of the pair of pillars 2a. The beam 2b is supported on the pair of pillars 2a. In the example illustrated in FIG. 1, the beam 2b extends in the direction along the X axis and has a plate-like shape whose thickness direction is along the Z axis. The pair of rails 2c is arranged on a surface of the beam 2b that is directed toward the Z1 direction. Each of the pair of rails 2c is a linear rail that guides the movable body 2d to move relative to the pair of pillars 2a and the beam 2b in the direction along the X axis, and extends in the direction along the X axis. The movable body 2d is attached to the pair of rails 2c via linear movement bearings (not illustrated). The movable body 2d is a member that moves with respect to the pair of pillars 2a and the beam 2b in the direction along the X axis. In the example illustrated in FIG. 1, the movable body 2d has a plate-like shape whose thickness direction is the direction along the Z axis. Although not illustrated, the X-axis movement mechanism 2X includes an actuator including an electric motor such as a servomotor that generates a driving force for the movement, and an encoder such as a linear encoder that detects the amount of the movement. The configuration of the X-axis movement mechanism 2X is not limited to the example illustrated in FIG. 1.

The Z-axis movement mechanisms 2Z_1 to 2Z_5 are attached to the movable body 2d of the X-axis movement mechanism 2X described above via a support 2e. As a result, the Z-axis movement mechanisms 2Z_1 to 2Z_5 move in the direction along the X axis as the movable body 2d moves.

Here, the support 2e is attached to the movable body 2d via a linear movement mechanism (not illustrated). The linear movement mechanism moves the support 2e in the direction along the Z axis with respect to the movable body 2d. As a result, the Z-axis movement mechanisms 2Z_1 to 2Z_5 collectively move in the direction along the Z axis. The linear movement mechanism may be, for example, an electric mechanism whose configuration is similar to that of the Z-axis movement mechanism 2Z, or may be a manual mechanism. When the linear movement mechanism is an electric mechanism, the linear movement mechanism may be driven during printing.

Each of the Z-axis movement mechanisms 2Z_1 to 2Z_4 is a linear movement mechanism that changes the position of the head unit 3 with respect to the workpiece W along the Z axis. In the example illustrated in FIG. 1, the Z-axis movement mechanisms 2Z_1 to 2Z_4 are attached to the movable body 2d of the X-axis movement mechanism 2X via the support 2e, and move the head units 3 in the direction along the Z axis. Further, the Z-axis movement mechanisms 2Z_1 to 2Z_4 are arranged in this order in the X1 direction.

Here, the Z-axis movement mechanisms 2Z_1 to 2Z_4 correspond to the head units 3_1 to 3_4 on a one-to-one basis. Each of the head units 3 is attached to each of the Z-axis movement mechanisms 2Z_1 to 2Z_4. Therefore, the Z-axis movement mechanism 2Z_1 changes the relative position of the head unit 31 with respect to the workpiece W in the direction along the Z axis. Similarly, the Z-axis movement mechanism 2Z_2 changes the relative position of the head unit 32 with respect to the workpiece W in the direction along the Z axis, the Z-axis movement mechanism 2Z_3 changes the relative position of the head unit 3_3 with respect to the workpiece W in the direction along the Z axis, and the Z-axis movement mechanism 2Z_4 changes the relative position of the head unit 34 with respect to the workpiece W in the direction along the Z axis. In this way, the Z-axis movement mechanisms 2Z_1 to 2Z_4 change the relative positions of the head units 3_1 to 3_4 with respect to the workpiece W in the direction along the Z axis independently of each other.

On the other hand, the Z-axis movement mechanism 2Z_5 is a linear movement mechanism that changes the position of the sensor unit 30 with respect to the workpiece W along the Z axis, and operates independently of each of the Z-axis movement mechanisms 2Z_1 to 2Z_4. The sensor unit 30 is attached to the Z-axis movement mechanism 2Z_5. In the example illustrated in FIG. 1, the Z-axis movement mechanism 2Z_5 is attached to the movable body 2d of the X-axis movement mechanism 2X via the support 2e, and moves the sensor unit 30 in the direction along the Z axis. In this way, the Z-axis movement mechanism 2Z_5 changes the relative position of the sensor unit 30 with respect to the workpiece W in the direction along the Z axis independently of each of the head units 3_1 to 3_4.

The Z-axis movement mechanisms 2Z_1 to 2Z_5 described above have the same configuration except that movement targets thereof are different from those described above. Although not illustrated, each of the Z-axis movement mechanisms 2Z_1 to 2Z_5 includes the rails, the movable body, the actuator, and the encoder. The rails are linear rails fixed to the support 2e and extending in the direction along the Z axis. The movable body is attached to the rails via the linear movement bearings and moves in the direction along the Z axis. The actuator includes an electric motor such as a servomotor that generates a driving force for the movement. The encoder is a linear encoder or the like that detects the amount of the movement. The configurations of the Z-axis movement mechanisms 2Z_1 to 2Z_5 may be different from each other. However, the Z-axis movement mechanisms 2Z_1 to 2Z_5 may have the same configuration to achieve cost reduction or the like.

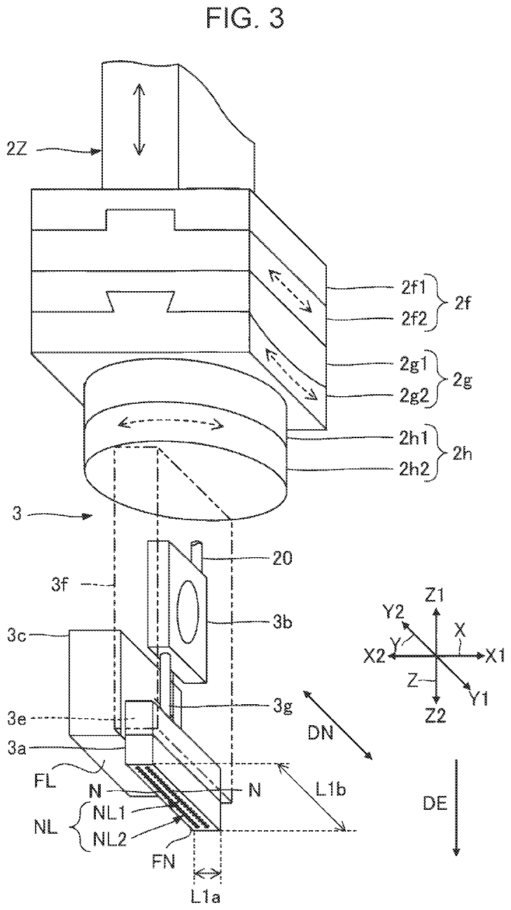

Although not illustrated in FIG. 1, the head unit 3 or the sensor unit 30 is attached to the movable body via an adjustment mechanism for finely adjusting the posture of the head unit 3 or the sensor unit 30. A specific example of the adjustment mechanism will be described below with reference to FIG. 3.

Each of the head units 3_1 to 3_4 is an assembly including a head 3a that ejects ink, which is an example of a “liquid”, toward the workpiece W. Details of the head unit 3 will be described below with reference to FIG. 3.

The ink is not particularly limited, and examples of the ink include water-based ink in which a coloring material such as a dye or pigment is dissolved in a water-based solvent, curable ink using a curable resin such as an ultraviolet curable resin, and solvent-based ink in which a coloring material such as a dye or pigment is dissolved in an organic solvent. Among them, the curable ink may be used as appropriate. The curable ink is not particularly limited, and may be, for example, thermosetting ink, photocurable ink, radiation curable ink, or electron beam curable ink, and photocurable ink such as ultraviolet curable ink may be suitable. The ink is not limited to a solution, and may be ink in which a coloring material or the like is dispersed as a dispersoid in a dispersion medium. Further, the ink is not limited to ink containing a coloring material. For example, the ink may be ink containing conductive particles such as metal particles for forming a wiring or the like as a dispersoid, clear ink, or a treatment liquid for surface treatment of the workpiece W.

A wiring and a supply pipe (not illustrated) are coupled to the head unit 3. The wiring supplies, to the head 3a, an electrical signal for driving the head 3a. The wiring may be arranged on the same path as the supply pipe, or may be arranged on a path different from that of the supply pipe. The supply pipe is a flexible pipe that supplies the ink from an ink tank (not illustrated) to the head unit 3.

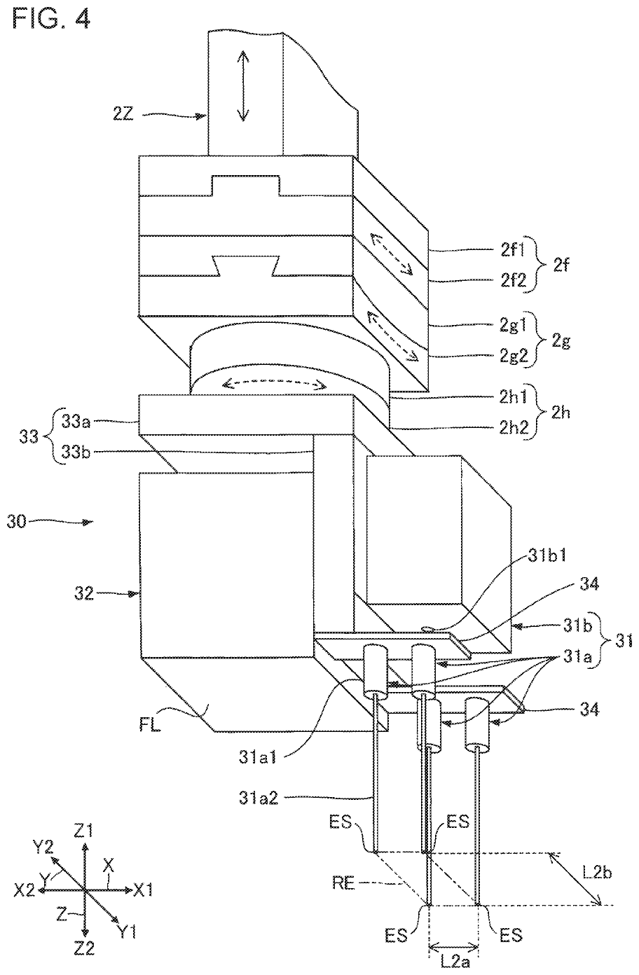

The sensor unit 30 is an assembly including a sensor 31 that detects a positional relationship with respect to the workpiece W. Details of the sensor unit 30 will be described below with reference to FIG. 4.

The support mechanism 4 is a mechanism that supports the workpiece W. In the example illustrated in FIG. 1, the support mechanism 4 includes a Y-axis movement mechanism 4Y.

The Y-axis movement mechanism 4Y is a linear movement mechanism that changes the relative positions of the head units 3_1 to 3_4 and the sensor unit 30 with respect to the workpiece W in the direction along the Y axis. In the example illustrated in FIG. 1, the Y-axis movement mechanism 4Y moves the workpiece W in the direction along the Y axis.

The Y-axis movement mechanism 4Y includes a support 4a, a pair of rails 4b, and a movable body 4c. The support 4a, the pair of rails 4b, and the movable body 4c are formed of metal such as iron, stainless steel, or an aluminum alloy.

The support 4a is a member fixed to the surface 10a of the base 10 by screws or the like. In the example illustrated in FIG. 1, the support 4a extends in the direction along the Y axis and has a plate-like shape whose thickness direction is the direction along the Z axis. The pair of rails 4b is arranged on a surface of the support 4a that is directed toward the Z1 direction. Each of the pair of rails 4b is a linear rail that guides the movable body 4c to move relative to the support 4a in the direction along the Y axis, and extends in the direction along the Y axis. The movable body 4c is attached to the pair of rails 4b via linear movement bearings (not illustrated). The movable body 4c is a member that moves relative to the support 4a in the direction along the Y axis. In the example illustrated in FIG. 1, the movable body 4c has a plate-like shape whose thickness direction is the direction along the Z axis. Although not illustrated, the Y-axis movement mechanism 4Y includes an actuator including an electric motor such as a servomotor that generates a driving force for the movement, and an encoder such as a linear encoder that detects the amount of the movement.

A stage 4d is attached to the movable body 4c. The stage 4d is a member for mounting the workpiece W thereon. In the example illustrated in FIG. 1, the stage 4d has a plate-like shape. Here, although not illustrated, an adjustment mechanism for rotating the stage 4d around an axis parallel to the X axis with respect to the movable body 4c is interposed between the movable body 4c and the stage 4d. With the adjustment mechanism, the posture of the workpiece W around the axis parallel to the X axis can be finely adjusted. The adjustment mechanism may be an electric mechanism including an actuator and an encoder, or may be a manual adjustment mechanism.

The configuration of the Y-axis movement mechanism 4Y is not limited to the example illustrated in FIG. 1. For example, the support 4a may be omitted, or the support 4a may be integrated with the pair of rails 4b. When the support 4a is omitted, the pair of rails 4b is directly fixed to the base 10 by screws or the like. Further, the adjustment mechanism interposed between the movable body 4c and the stage 4d may be provided as necessary or may be omitted.

The maintenance mechanism 12 is a mechanism for performing maintenance of the head 3a of the head unit 3. In the example illustrated in FIG. 1, the maintenance mechanism 12 includes a unit 12a and a unit 12b.

Although not illustrated, the unit 12a includes a cap, a wiper, and a suction mechanism. The cap is implemented by an elastic member such as rubber, and covers a nozzle and a nozzle surface of the head 3a to prevent ink near the nozzle of the head 3a from drying. Further, when the ink is a photocurable ink, the cap covers the nozzle surface of the head 3a and blocks external light, thereby preventing thickening or solidification of the ink near the nozzle of the head 3a. The wiper wipes the nozzle surface of the head 3a to clean the nozzle surface. The suction mechanism sucks the ink from the nozzle of the head 3a in a state in which the nozzle surface is covered with the cap to refresh the ink in the nozzle.

The unit 12b is a mechanism for inspecting an ink ejection function of the head 3a. For example, the unit 12b supports a medium such as paper or film for printing a pattern for inspection. In the example illustrated in FIG. 1, the unit 12b is configured to be movable in the direction along the Y axis, and switches between a state in which the unit 12b overlaps with the unit 12a when viewed in the direction along the Z axis and a state in which the unit 12b does not overlap with the unit 12a when viewed in the direction along the Z axis. Here, when the unit 12a is not used, the unit 12b overlaps with the unit 12a when viewed in the direction along the Z axis, and functions as a cover that covers the unit 12a. On the other hand, when the unit 12a is used, the unit 12b does not overlap with the unit 12a when viewed in the direction along the Z axis.

The configuration of the maintenance mechanism 12 is not limited to the example illustrated in FIG. 1, and may be arbitrary. Further, the maintenance mechanism 12 may be provided as necessary or may be omitted.

### 1-2. Electrical Configuration of Three-dimensional Object Printing Apparatus

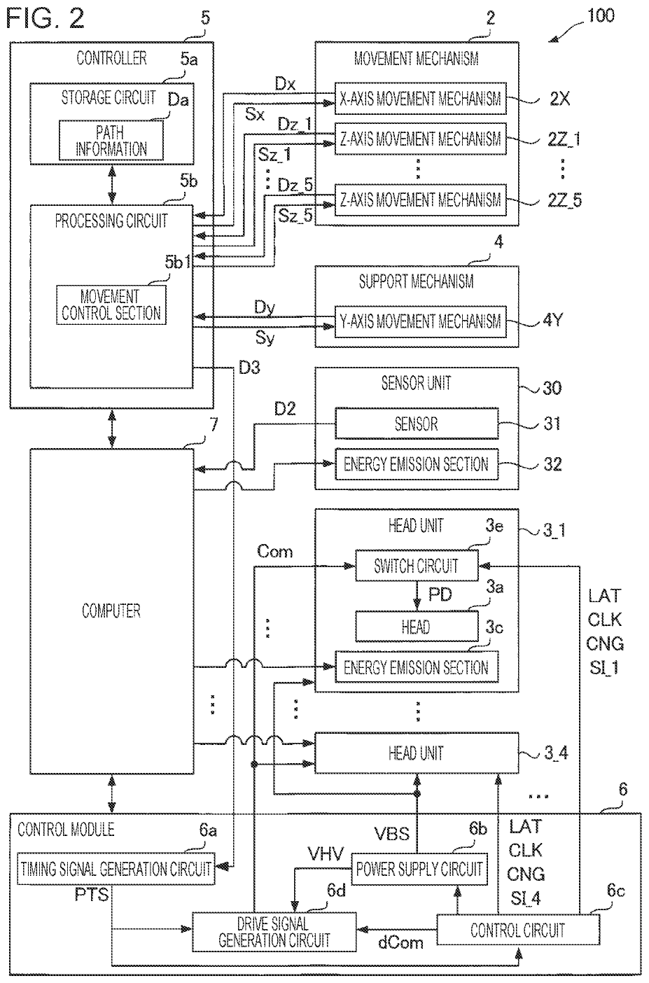

FIG. 2 is a block diagram illustrating an electrical configuration of the three-dimensional object printing apparatus 1 according to the first embodiment. FIG. 2 illustrates electrical components among the components of the three-dimensional object printing apparatus 1. As illustrated in FIG. 2, the three-dimensional object printing apparatus 1 includes a controller 5, a control module 6, and a computer 7 in addition to the above-described components illustrated in FIG. 1. Hereinafter, the controller 5, the control module 6, and the computer 7 will be sequentially described.

The respective electrical components illustrated in FIG. 2 may be divided as appropriate, and some of the electrical components may be included in or integrated with another component. For example, some or all of the functions of the controller 5 or the control module 6 may be implemented by the computer 7, or may be implemented by another external apparatus such as a personal computer (PC) connected to the controller 5 via a network such as a local area network (LAN) or the Internet.

The controller 5 has a function of controlling driving of the movement mechanism 2 and the support mechanism 4 and a function of generating a signal D3 for synchronizing an ink ejection operation of the head unit 3 with an operation of the movement mechanism 2.

The controller 5 includes a storage circuit 5a and a processing circuit 5b.

The storage circuit 5a stores various programs executed by the processing circuit 5b and various data processed by the processing circuit 5b. The storage circuit 5a includes, for example, one of or both of a volatile semiconductor memory such as a random access memory (RAM), and a non-volatile semiconductor memory such as a read only memory (ROM), an electrically erasable programmable read only memory (EEPROM), or a programmable ROM (PROM). A part or all of the storage circuit 5a may be included in the processing circuit 5b.

Path information Da is stored in the storage circuit 5a. The path information Da is information used for controlling the operation of the movement mechanism 2 and indicating the position of the head 3a on a path along which the head 3a is to move. The path information Da is expressed using, for example, coordinate values of the world coordinate system. The path information Da is generated by the computer 7 based on workpiece data indicating at least a partial shape of the workpiece W. The path information Da is input from the computer 7 to the storage circuit 5a. The path information Da is expressed using coordinate values of a workpiece coordinate system. In this case, the path information Da is used for controlling the operation of the movement mechanism 2 after conversion of the coordinate values of the workpiece coordinate system to the coordinate values of the world coordinate system.

The processing circuit 5b functions as a movement control section 5b1 that controls the operations of the movement mechanism 2, and also generates the signal D3. For example, the processing circuit 5b includes at least one processor such as a central processing unit (CPU). The processing circuit 5b may include, instead of or in addition to the CPU, a programmable logic device such as a field-programmable gate array (FPGA).

The movement control section 5b1 is implemented by executing a program read from the storage circuit 5a or the like by the processing circuit 5b. The movement control section 5b1 performs computation for converting the path information Da into operation amounts such as movement amounts and movement speeds of the movement mechanism 2. Then, the movement control section 5b1 outputs control signals Sx, and Sz_1 to Sz_5 based on output signals Dx, and Dz_1 to Dz_5 from the respective encoders of the movement mechanism 2 in such a way that the actual operation amounts of the movement mechanism 2 are obtained as a result of the above-described computation. The output signal Dx is output from the encoder of the X-axis movement mechanism 2X. The output signals Dz_1 to Dz_5 are output from the encoders of the Z-axis movement mechanisms 2Z_1 to 2Z_5, respectively. The control signal Sx is a signal for controlling driving of the actuator of the X-axis movement mechanism 2X. The control signals Sz_1 to Sz_5 are signals for controlling driving of the actuators of the Z-axis movement mechanisms 2Z_1 to 2Z_5. Here, the control signals Sx, and Sz_1 to Sz_5 are corrected by the movement control section 5b1 based on an output signal D1 from the sensor 31 of the sensor unit 30 as necessary.

As described above, the movement control section 5b1 controls the driving of the Z-axis movement mechanisms 2Z_1 to 2Z_5 independently. Apart or all of the movement control section 5b1 may be implemented by another apparatus such as the computer 7 or the like.

The processing circuit 5b generates the signal D3 based on at least one of the output signals Dx, and Dz_1 to Dz_5. For example, the processing circuit 5b generates the signal D3 including a pulse at a timing at which the output signal Dx becomes a predetermined value.

The control module 6 is a circuit that controls the ink ejection operation of the head unit 3 based on the signal D3 output from the controller 5 and print data from the computer 7. The control module 6 includes a timing signal generation circuit 6a, a power supply circuit 6b, a control circuit 6c, and a drive signal generation circuit 6d.

The timing signal generation circuit 6a generates a timing signal PTS based on the signal D3. The timing signal generation circuit 6a is implemented by, for example, a timer that starts generation of the timing signal PTS upon detection of the signal D3.

The power supply circuit 6b receives power from a commercial power supply (not illustrated) and generates various predetermined potentials. Various generated potentials are appropriately supplied to the respective parts of the control module 6 and the head unit 3. For example, the power supply circuit 6b generates a power supply potential VHV and an offset potential VBS. The offset potential VBS is supplied to the head unit 3. Further, the power supply potential VHV is supplied to the drive signal generation circuit 6d.

The control circuit 6c generates control signals SI_1 to SI_4, a waveform designation signal dCom, a latch signal LAT, a clock signal CLK, and a change signal CNG based on the timing signal PTS. These signals are synchronized with the timing signal PTS. Among these signals, the waveform designation signal dCom is input to the drive signal generation circuit 6d, and the other signals are input to a switch circuit 3e of the head unit 3. The control signals SI_1 to SI_4 correspond to the head units 3_1 to 3_4 on a one-to-one basis. Hereinafter, each of the control signals SI_1 to SI_4 may be referred to as a control signal SI.

The control signal SI is a digital signal for designating an operation state of a driving element included in the head 3a of the head unit 3. Specifically, the control signal SI is a signal for designating whether or not to supply a drive signal Com to be described later to the driving element based on the print data. By the designation, for example, whether or not to eject ink from a nozzle corresponding to the driving element is designated, or the amount of ink to be ejected from the nozzle is designated. The waveform designation signal dCom is a digital signal for designating a waveform of the drive signal Com. The latch signal LAT and the change signal CNG are used together with the control signal SI, and are signals for specifying a timing of ejecting the ink from the nozzle by specifying a driving timing of the driving element. The clock signal CLK is a reference clock signal synchronized with the timing signal PTS.

The control circuit 6c described above includes, for example, one or more processors such as CPUs. The control circuit 6c may include, instead of or in addition to the CPU, a programmable logic device such as an FPGA.

The drive signal generation circuit 6d is a circuit that generates the drive signal Com for driving each driving element included in the head 3a of the head unit 3. Specifically, the drive signal generation circuit 6d includes, for example, a DA conversion circuit and an amplifying circuit. In the drive signal generation circuit 6d, the waveform designation signal dCom from the control circuit 6c is converted by the DA conversion circuit from a digital signal to an analog signal, and the amplifying circuit amplifies the analog signal by using the power supply potential VHV from the power supply circuit 6b, thereby generating the drive signal Com. Here, a signal having a waveform actually supplied to the driving element among waveforms included in the drive signal Com is a driving pulse PD. The driving pulse PD is supplied from the drive signal generation circuit 6d to the driving element via the switch circuit 3e of the head unit 3.

Here, the switch circuit 3e is a circuit including a switching element that switches whether or not to supply, as the driving pulse PD, at least some of the waveforms included in the drive signal Com based on the control signal SI.

The computer 7 is a desktop or notebook computer in which a program such as a program PG is installed. The computer 7 has a function of generating the path information Da, a function of supplying information such as the path information Da to the controller 5, and a function of supplying information such as the print data to the control module 6. In addition to these functions, the computer 7 according to the present embodiment has a function of controlling driving of an energy emission section 3c of the head unit 3 and an energy emission section 32 of the sensor unit 30.

### 1-3. Configuration of Head Unit

FIG. 3 is a perspective view illustrating schematic configurations of the head unit 3 and adjustment mechanisms 2f, 2g, and 2h. As illustrated in FIG. 3, the head unit 3 is supported on the Z-axis movement mechanism 2Z via the adjustment mechanisms 2f, 2g, and 2h. In the example illustrated in FIG. 3, the adjustment mechanisms 2f, 2g, and 2h are arranged in this order in the Z2 direction.

The adjustment mechanism 2f is a mechanism for finely adjusting a positional relationship of the Z-axis movement mechanism 2Z and the head unit 3 in the direction along the Y axis. In the example illustrated in FIG. 3, the adjustment mechanism 2f includes a first member 2f1 and a second member 2f2 whose relative positions in the direction along the Y axis can be changed. Although not illustrated, the adjustment mechanism 2f is provided with a knob or the like for the fine adjustment, so that the fine adjustment can be manually performed. The first member 2f1 is attached to the Z-axis movement mechanism 2Z by screws or the like. The first member 2f1 may be integrated with the Z-axis movement mechanism 2Z.

The adjustment mechanism 2g is a mechanism for finely adjusting an angular relationship of the Z-axis movement mechanism 2Z and the head unit 3 around an axis parallel to the X axis. In the example illustrated in FIG. 3, the adjustment mechanism 2g includes a first member 2g1 and a second member 2g2 whose relative angles around the axis parallel to the X axis can be changed. The adjustment mechanism 2g is provided with a knob or the like for the fine adjustment, so that the fine adjustment can be manually performed. The first member 2g1 is attached to the second member 2f2 of the adjustment mechanism 2f. The first member 2g1 may be integrated with the second member 2f2.

The adjustment mechanism 2h is a mechanism for finely adjusting an angular relationship of the Z-axis movement mechanism 2Z and the head unit 3 around an axis parallel to the Z axis. In the example illustrated in FIG. 3, the adjustment mechanism 2h includes a first member 2h1 and a second member 2h2 whose relative angles around the axis parallel to the Z axis can be changed. Although not illustrated, the adjustment mechanism 2h is provided with a knob or the like for the fine adjustment, so that the fine adjustment can be manually performed. The first member 2h1 is attached to the second member 2g2 of the adjustment mechanism 2g. The first member 2h1 may be integrated with the second member 2g2.

The order in which the adjustment mechanisms 2f, 2g, and 2h are arranged is not limited to the example illustrated in FIG. 3, and may be arbitrary. Further, the adjustment mechanisms 2f, 2g, and 2h may be configured to electrically perform fine adjustment.

The head unit 3 includes the head 3a, a pressure regulating valve 3b, and the energy emission section 3c. The head 3a, the pressure regulating valve 3b, and the energy emission section 3c are supported on a support 3f indicated by a line with alternating long and two short dashes in FIG. 3. In the example illustrated in FIG. 3, each of the number of heads 3a, the number of pressure regulating valves 3b, and the number of energy emission sections 3c of the head unit 3 is one. However, each of the number of heads 3a, the number of pressure regulating valves 3b, and the number of energy emission sections 3c of the head unit 3 is not limited to that in the example illustrated in FIG. 3, but may be two or more. Further, the pressure regulating valve 3b may be provided outside the head unit 3.

The support 3f is a substantially rigid body, and is formed of, for example, a metal material. Although the support 3f has a flattened box shape in FIG. 3, the shape of the support 3f is not particularly limited and may be arbitrary.

The support 3f described above is mounted on the Z-axis movement mechanism 2Z via the adjustment mechanisms 2f, 2g, and 2h described above. Therefore, the head 3a, the pressure regulating valve 3b, and the energy emission section 3c are collectively supported on the Z-axis movement mechanism 2Z by the support 3f. In the example illustrated in FIG. 3, the pressure regulating valve 3b is arranged at a position in the Z1 direction with respect to the head 3a. The energy emission section 3c is arranged at a position in the X2 direction with respect to the head 3a.

The head 3a has a nozzle surface FN and includes a plurality of nozzles N formed in the nozzle surface FN. The nozzle surface FN is a nozzle surface in which the nozzles N are formed, and is formed of a material such as silicon (Si) or metal. Alternatively, when another member is arranged as a component of the head unit 3 on a plane extending from a plate surface of the nozzle surface FN, the nozzle surface FN includes the nozzle plate surface and the surface of the another member. In the example illustrated in FIG. 3, a normal direction of the nozzle surface FN, that is, an ink ejection direction DE from the nozzles N is the Z2 direction.

The plurality of nozzles N are divided into a first nozzle row NL1 and a second nozzle row NL2 that are spaced apart from each other in the direction along the X axis. Each of the first nozzle row NL1 and the second nozzle row NL2 is a set of the plurality of nozzles N linearly arranged in a nozzle row direction DN that is the direction along the Y axis. Here, an element related to each nozzle N of the first nozzle row NL1 and an element related to each nozzle N of the second nozzle row NL2 in the head 3a are approximately symmetrical to each other in the direction along the X axis.

However, positions of the plurality of nozzles N in the first nozzle row NL1 and positions of the plurality of nozzles N in the second nozzle row NL2 in the direction along the Y axis may coincide with or be different from each other. Further, the element related to each nozzle N of any one of the first nozzle row NL1 and the second nozzle row NL2 may be omitted. Hereinafter, a configuration in which the positions of the plurality of nozzles N in the first nozzle row NL1 and the positions of the plurality of nozzles N in the second nozzle row NL2 in the direction along the Y axis coincide with each other will be described by way of example.

Although not illustrated, the head 3a includes a piezoelectric element that is the driving element and a cavity that stores the ink for each nozzle N. Here, the piezoelectric element changes a pressure of the cavity corresponding to the piezoelectric element to eject the ink in the ejection direction DE from the nozzle corresponding to the cavity. Such a head 3a can be obtained, for example, by bonding a plurality of substrates such as silicon substrates appropriately processed by etching or the like with an adhesive or the like. A heater for heating ink in the cavity may be used instead of the piezoelectric element as the driving element for ejecting the ink from the nozzle.

The ink is supplied from the ink tank (not illustrated) through a supply pipe 20 to the head 3a. Here, the pressure regulating valve 3b is interposed between the supply pipe 20 and the head 3a. Here, the pressure regulating valve 3b is coupled to the head 3a via a head coupling flow path 3g implemented by a tubular body for transferring the ink.

The energy emission section 3c emits energy such as light, heat, an electron beam, or a radiation beam for semi-curing or semi-solidifying the ink on the workpiece W from an emission surface FL in the Z2 direction. The term “semi-cured” refers to a state of being partially cured without achieving complete curing. Similarly, the term “semi-solidified” refers to a state of being partially solidified without achieving complete solidification. The energy emission section 3c is implemented by, for example, a light emitting element such as a light emitting diode (LED) that emits ultraviolet rays. The energy emission section 3c may include an optical component such as a lens for adjusting an energy emitting direction or an energy emitting range. It is sufficient that the energy emission section 3c be provided as necessary, and the energy emission section 3c may be omitted. Further, the energy emission section 3c may completely cure the ink on the workpiece W, like the energy emission section 32 to be described later.

### 1-4. Configuration of Sensor Unit

FIG. 4 is a perspective view illustrating schematic configurations of the sensor unit 30 and the adjustment mechanisms 2f, 2g, and 2h. As illustrated in FIG. 4, the sensor unit 30 is supported on the Z-axis movement mechanism 2Z via the adjustment mechanisms 2f, 2g, and 2h, similarly to the head unit 3. In the example illustrated in FIG. 4, the adjustment mechanisms 2f, 2g, and 2h are arranged in this order in the Z2 direction. The order in which the adjustment mechanisms 2f, 2g, and 2h are arranged is not limited to the example illustrated in FIG. 4, and may be arbitrary. Further, the adjustment mechanisms 2f, 2g, and 2h may be configured to electrically perform fine adjustment.

The sensor unit 30 includes the sensor 31 and the energy emission section 32. The sensor 31 and the energy emission section 32 are supported on a support 33. Here, the sensor 31 includes a plurality of contact sensors 31a and a distance sensor 31b, and the plurality of contact sensors 31a are supported on the support 33 via an attachment member 34.

The support 33 is a substantially rigid body, and is formed of, for example, a metal material. In the example illustrated in FIG. 4, the support 33 includes two members 33a and 33b. The member 33a is a plate-like member whose thickness direction is the direction along the Z axis. A surface of the member 33a that is directed toward the Z1 direction is attached to the Z-axis movement mechanism 2Z via the adjustment mechanisms 2f, 2g, and 2h. On the other hand, the member 33b is fixed by screws or the like to a surface of the member 33a that is directed toward the Z2 direction. The member 33b is a plate-like member whose thickness direction is the direction along the X axis. A distance sensor 31b is fixed by screws or the like to a surface of the member 33b that is directed toward the X1 direction. On the other hand, the energy emission section 32 is fixed by screws or the like to a surface of the member 33b that is directed toward the X2 direction. On the other hand, the attachment member 34 is fixed by screws or the like to a surface of the member 33b that is directed toward the Z2 direction. The attachment member 34 is a substantially rigid body, and is formed of, for example, a metal material.

The shapes of the support 33 and the attachment member 34 are not limited to the example illustrated in FIG. 4, and may be arbitrary. Further, the attachment member 34 may be provided as necessary or may be omitted. In this case, the plurality of contact sensors 31a are directly fixed to the support 33 by screws or the like.

Each of the plurality of contact sensors 31a is a contact sensor that detects contact with the workpiece W. Each contact sensor 31a includes a base 31a1 and a wire 31a2. The base 31a1 is a tactile switch fixed to the attachment member 34 and includes a detection section that detects an external force. The wire 31a2 is attached to the detection section. The wire 31a2 extends in the direction along the Z axis, receives an external force in a direction orthogonal to the Z axis, and transmits the external force to the detection section.

Distal ends ES of the plurality of contact sensors 31a are arranged on the same virtual plane orthogonal to the Z axis. In the example illustrated in FIG. 4, the number of contact sensors 31a is four, and the shape of a distal end region RE defined by the four distal ends ES is a rectangular shape having a pair of short sides along the X axis and a pair of long sides along the Y axis.

Here, the shape of the distal end region RE is the same as the shape of the nozzle surface FN described above. Therefore, a length L2a of the distal end region RE in the direction along the X axis is equal to a length L1a of the nozzle surface FN in the direction along the X axis. Further, a length L2b of the distal end region RE in the direction along the Y axis is equal to a length L1b of the nozzle surface FN in the direction along the Y axis. A longitudinal direction of the distal end region RE is parallel to a longitudinal direction of the nozzle surface FN.

The distance sensor 31b is an optical displacement sensor that detects a distance to the workpiece W. The distance sensor 31b includes an emission section 31b1 that emits laser light toward the workpiece W, and outputs a signal according to a distance to the workpiece W in the direction along the Z axis based on a result of receiving the laser light reflected by the workpiece W. It is sufficient that the distance sensor 31b be provided as necessary, and the distance sensor 31b may be omitted.

The energy emission section 32 emits energy such as light, heat, an electron beam, or a radiation beam for curing or solidifying the ink on the workpiece W from an emission surface FL in the Z2 direction. The energy emission section 32 is implemented by, for example, a light emitting element such as a light emitting diode (LED) that emits ultraviolet rays. The energy emission section 32 may include an optical component such as a lens for adjusting an energy emitting direction or an energy emitting range.

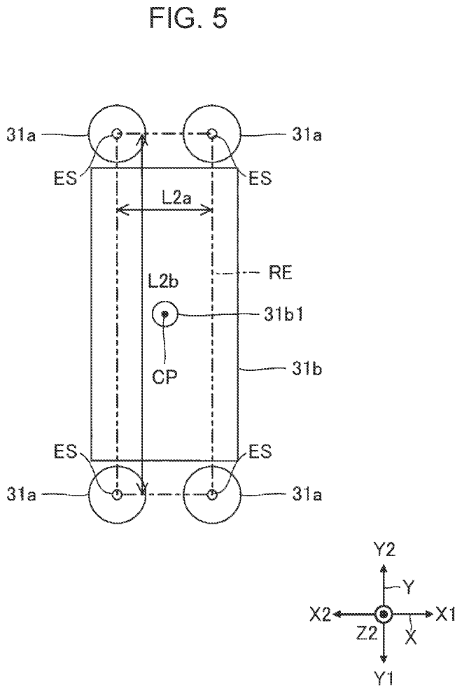

FIG. 5 is a diagram for describing the distal end region RE of the contact sensors 31a. The distance sensor 31b described above is arranged at a position in the Z1 direction with respect to the distal end region RE, and detects a distance to the workpiece W through the distal end region RE. In the example illustrated in FIG. 5, the emission section 31b1 of the distance sensor 31b is positioned at a center CP of the distal end region RE when viewed in the direction along the Z axis.

### 1-5. Operation of Three-dimensional Object Printing Apparatus

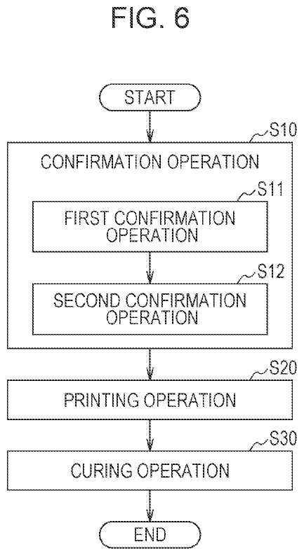

FIG. 6 is a diagram illustrating an example of an operation of the three-dimensional object printing apparatus 1 according to the first embodiment. As illustrated in FIG. 6, the three-dimensional object printing apparatus 1 performs a confirmation operation S10, a printing operation S20, and a curing operation S30 in this order. In the example illustrated in FIG. 6, in the confirmation operation S10, a first confirmation operation S11 and a second confirmation operation S12 are performed in this order. In these operations, the movement control section 5b1 illustrated in FIG. 2 controls the operations of the movement mechanism 2 to change the positions of the head units 3 and the sensor unit 30 in the directions along the X axis and the Z axis. One of the first confirmation operation S11 and the second confirmation operation S12 may be omitted.

In the confirmation operation S10, the X-axis movement mechanism 2X is operated within a range in which each of the head 3a and the sensor 31 overlaps with the workpiece W when viewed in the direction along the Z axis, and the head 3a does not eject the ink for image formation on the surface of the workpiece W. In the confirmation operation S10, the validity of the path based on the path information Da described above is determined based on a detection result of the sensor 31. According to the present embodiment, in the first confirmation operation S11, the validity of the path based on the path information Da described above is determined based on a detection result of the distance sensor 31b. Further, in the second confirmation operation S12, the validity of the path based on the path information Da described above is determined based on a detection result of the contact sensors 31a.

The printing operation S20 is an operation performed after the confirmation operation S10, and in the printing operation S20, the X-axis movement mechanism 2X is operated within the range in which each of the head 3a and the sensor 31 overlaps with the workpiece W when viewed in the direction along the Z axis, and the head 3a ejects the ink. Here, the energy emission section 3c emits energy over a period during which the printing operation S20 is being performed, as necessary. Therefore, the ink is irradiated with the energy immediately after landing on the workpiece W. As a result, the ink on the workpiece W is pinned on the workpiece W by being semi-cured or semi-solidified.

The curing operation S30 is an operation performed after the printing operation S20, and in the curing operation S30, the X-axis movement mechanism 2X is operated within a range in which the energy emission section 32 overlaps with the workpiece W when viewed the direction along the Z axis, and the energy emission section 32 emits energy. As a result, the ink on the workpiece W is cured or solidified. Here, from the viewpoint of accelerating curing or solidification of the ink on the workpiece W, not only the energy emission section 32 but also the energy emission section 3c may emit energy over a period during which the curing operation S30 is being performed.

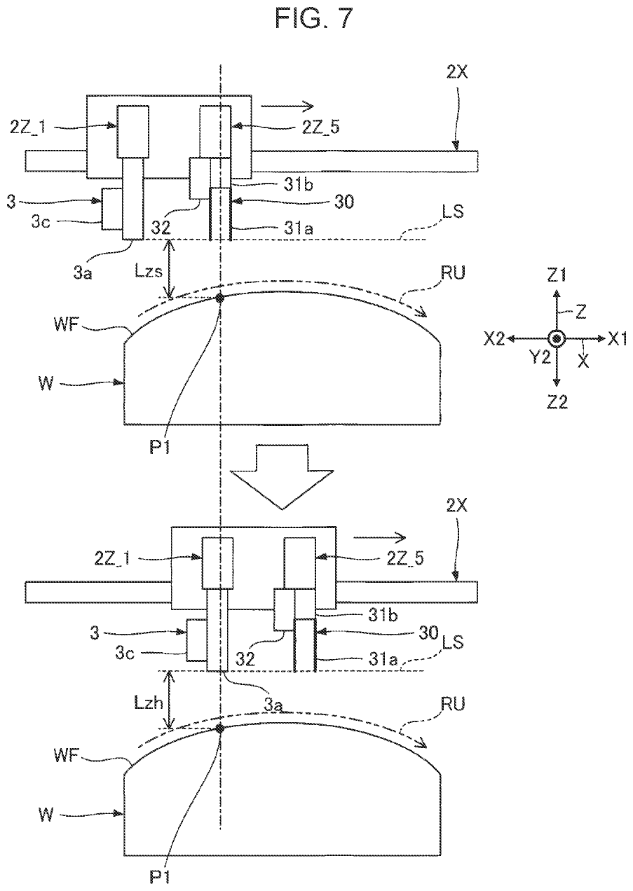

These operations will be described in detail below with reference to FIGS. 7 to 10. In FIGS. 7 to 10, among the plurality of Z-axis movement mechanisms 2Z supported on the X-axis movement mechanism 2X, the Z-axis movement mechanism 2Z_1 and the Z-axis movement mechanism 2Z_5 are representatively illustrated for convenience of explanation. Further, in FIGS. 7 to 9, a case where a driving direction of the X-axis movement mechanism 2X is the X1 direction when the confirmation operation S10 or the printing operation S20 is performed. Here, in FIGS. 7 to 9, the upper parts show a state in which the position of the sensor unit 30 in the direction along the X axis is a position P1, and the lower parts show a state in which the position of the head unit 3 in the direction along the X axis is the position P1.

FIG. 7 is a diagram for describing the first confirmation operation S11 in the confirmation operation S10. Hereinafter, a change in positional relationship of the head unit 3 and the sensor unit 30 caused by the operations of the Z-axis movement mechanism 2Z_1 and the Z-axis movement mechanism 2Z_5 during the first confirmation operation S11 will be representatively described with reference to FIG. 7. The matters described below also apply to changes in positional relationship of the head units 3 and the sensor unit 30 caused by the operations of the Z-axis movement mechanisms 2Z_2 to 2Z_4 and the Z-axis movement mechanism 2Z_5 during the first confirmation operation S11.

As illustrated in FIG. 7, the position of the head 3a in the direction along the Z axis is constant over a period during which the first confirmation operation S11 is being performed. Similarly, the position of the sensor 31 in the direction along the Z axis is constant over the period during which the first confirmation operation S11 is being performed. That is, the Z-axis movement mechanism 2Z is not operated during the first confirmation operation S11. In the example illustrated in FIG. 7, the head 3a and the sensor 31 each move along a straight line LS parallel to the X axis over the period during which the first confirmation operation S11 is being performed. The straight line LS is positioned in the Z1 direction with respect to the path RU based on the path information Da, and may be a straight line passing through the position of the nozzle surface FN or the distal end region RE when the head 3a or the sensor 31 is retracted in the Z1 direction as much as possible.

Here, when the surface WF of the workpiece W is not parallel to the X axis as described above, a head distance Lzh, which is a distance between the head 3a and the workpiece W in the direction along the Z axis, changes as the head 3a moves in the direction along the X axis. Similarly, a sensor distance Lzs, which is a distance between the sensor 31 and the workpiece W in the direction along the Z axis, changes as the sensor 31 moves in the direction along the X axis.

An average value of the head distances Lzh during the first confirmation operation S11 as described above is larger than an average value of the head distances Lzh during the printing operation S20 to be described later. Therefore, collision between the head 3a and the workpiece W may be appropriately prevented during the first confirmation operation S11.

Here, an average value of the head distances Lzh during a certain operation is obtained by measuring the head distance Lzh multiple times at arbitrary time intervals, for example, from the start of the operation to the end of the operation, and dividing the total value of the head distances Lzh by the number of times the measurement is performed. Similarly, an average value of the sensor distances Lzs during a certain operation is obtained by measuring the sensor distance Lzs multiple times at arbitrary time intervals, for example, from the start of the operation to the end of the operation, and dividing the total value of the sensor distances Lzs by the number of times the measurement is performed.

Similarly, an average value of the sensor distances Lzs during the first confirmation operation S11 is larger than an average value of the sensor distances Lzs during the printing operation S20 to be described later. Moreover, an operation amount of the Z-axis movement mechanism 2Z_5 during the first confirmation operation S11 is smaller than an operation amount of the Z-axis movement mechanism 2Z_5 during the printing operation S20. Therefore, during the first confirmation operation S11, the shape of the surface WF can be suitably measured using the distance sensor 31b.

During the first confirmation operation S11, the validity of the path RU based on the path information Da described above is determined based on a detection result of the distance sensor 31b in consideration of the change in positional relationship of the head unit 3 and the sensor unit 30 as described above. Specifically, for example, when a difference between a path based on the detection result of the distance sensor 31b and the path RU based on the path information Da is within a predetermined range, it is determined that the path RU based on the path information Da is valid. On the other hand, when the difference between the path based on the detection result of the distance sensor 31b and the path RU based on the path information Da is outside the predetermined range, it is determined that the path RU based on the path information Da is not valid.

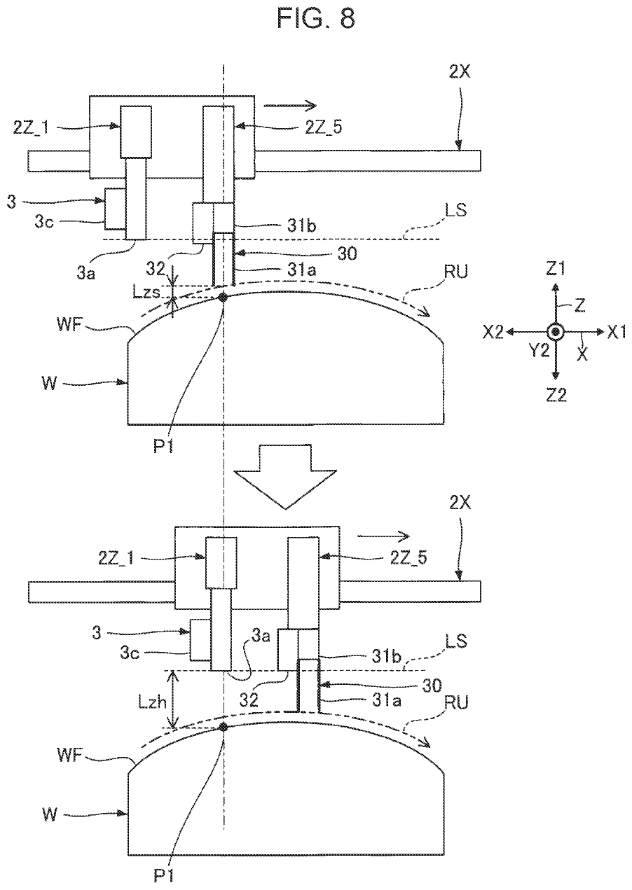

FIG. 8 is a diagram for describing the second confirmation operation S12 in the confirmation operation S10. Hereinafter, a change in positional relationship of the head unit 3 and the sensor unit 30 caused by the operations of the Z-axis movement mechanism 2Z_1 and the Z-axis movement mechanism 2Z_5 during the second confirmation operation S12 will be representatively described with reference to FIG. 8. The matters described below also apply to changes in positional relationship of the head units 3 and the sensor unit 30 caused by the operations of the Z-axis movement mechanisms 2Z_2 to 2Z_4 and the Z-axis movement mechanism 2Z_5 during the second confirmation operation S12.

As illustrated in FIG. 8, the position of the head 3a in the direction along the Z axis is constant over a period during which the second confirmation operation S12 is being performed. In the example illustrated in FIG. 8, the head 3a moves along the straight line LS parallel to the X axis over the period during which the second confirmation operation S12 is being performed. Here, as in the first confirmation operation S11, the head distance Lzh changes as the head 3a moves in the direction along the X axis.

On the other hand, the sensor distance Lzs is constant over the period during which the second confirmation operation S12 is being performed. Accordingly, the position of the sensor 31 in the direction along the Z axis changes along the surface WF of the workpiece W during the second confirmation operation S12. In the example illustrated in FIG. 8, the sensor 31 moves along the path RU based on the path information Da over the period during which the second confirmation operation S12 is being performed. That is, during the second confirmation operation S12, the Z-axis movement mechanism 2Z_5 is operated, whereas the Z-axis movement mechanism 2Z_1 is not operated.

An average value of the head distances Lzh during the second confirmation operation S12 as described above is larger than an average value of the head distances Lzh during the printing operation S20 to be described later. Therefore, collision between the head 3a and the workpiece W may be appropriately prevented during the second confirmation operation S12.

Further, during the second confirmation operation S12, the amount of change in head distance Lzh is larger than the amount of change in sensor distance Lzs. Moreover, during the second confirmation operation S12, the average value of the head distances Lzh is larger than an average value of the sensor distances Lzs. Therefore, collision between the head 3a and the workpiece W may be appropriately prevented during the second confirmation operation S12 also in this respect.

During the second confirmation operation S12, the validity of the path RU based on the path information Da described above is determined based on a detection result of the contact sensors 31a in consideration of the change in positional relationship of the head unit 3 and the sensor unit 30 as described above. Specifically, for example, when the contact sensors 31a do not come into contact with the workpiece W and other objects, it is determined that the path RU based on the path information Da is valid. On the other hand, when the contact sensors 31a come into contact with the workpiece W and other objects, it is determined that the path RU based on the path information Da is not valid.

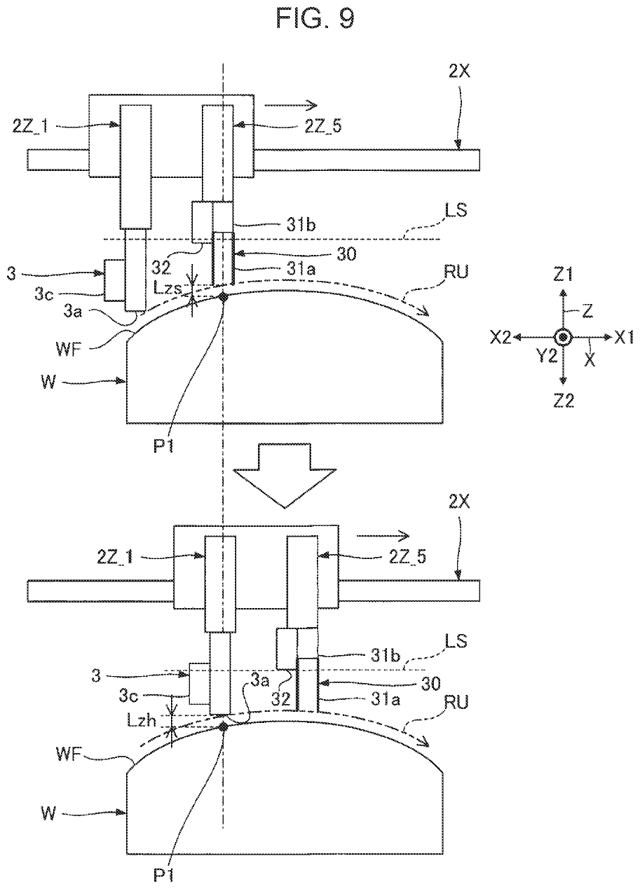

FIG. 9 is a diagram for describing the printing operation S20. Hereinafter, a change in positional relationship of the head unit 3 and the sensor unit 30 caused by the operations of the Z-axis movement mechanism 2Z_1 and the Z-axis movement mechanism 2Z_5 during the printing operation S20 will be representatively described with reference to FIG. 9. The matters described below also apply to changes in positional relationship of the head units 3 and the sensor unit 30 caused by the operations of the Z-axis movement mechanisms 2Z_2 to 2Z_4 and the Z-axis movement mechanism 2Z_5 during the printing operation S20.

As illustrated in FIG. 9, the head distance Lzh is constant over a period during which the printing operation S20 is being performed. Accordingly, the position of the head 3a in the direction along the Z axis changes along the surface WF of the workpiece W during the printing operation S20. Similarly, the sensor distance Lzs is constant over the period during which the printing operation S20 is being performed. Accordingly, the position of the sensor 31 in the direction along the Z axis changes along the surface WF of the workpiece W during the printing operation S20. In the example illustrated in FIG. 9, each of the head 3a and the sensor 31 moves along the path RU based on the path information Da over the period during which the printing operation S20 is being performed.

An average value of the head distances Lzh during the printing operation S20 as described above is smaller than an average value of the head distances Lzh during the confirmation operation S10. Therefore, image quality can be improved.

Further, the amount of change in head distance Lzh during the printing operation S20 is smaller than the amount of change in head distance Lzh during the confirmation operation S10. Therefore, the image quality can be improved also in this respect.

Furthermore, during the printing operation S20, an average value of the sensor distances Lzs is substantially the same as the average value of the head distances Lzh. Therefore, the distal end region RE can be moved along a path that is substantially the same as that of the nozzle surface FN. Note that “being substantially the same” includes not only a case of being exactly the same, but also a case of being subject to a degree of error such as a manufacturing error or an operational error.

Further, an operation amount of the Z-axis movement mechanism 2Z_5 during the printing operation S20 is larger than an operation amount of the Z-axis movement mechanism 2Z_5 during the first confirmation operation S11. In other words, the operation amount of the Z-axis movement mechanism 2Z_5 during the first confirmation operation S11 is smaller than the operation amount of the Z-axis movement mechanism 2Z_5 during the printing operation S20. By reducing the operation amount of the Z-axis movement mechanism 2Z_5 during the first confirmation operation S11, more suitably, by not operating the Z-axis movement mechanism 2Z_5, a decrease in measurement accuracy of the distance sensor 31b in the first confirmation operation S11 can be suppressed.

In addition, the average value of the sensor distances Lzs during the printing operation S20 is smaller than the average value of the sensor distances Lzs during the first confirmation operation S11. In other words, the average value of the sensor distances Lzs during the first confirmation operation S11 is larger than the average value of the sensor distances Lzs during the printing operation S20. Therefore, collision between the sensor 31 and the workpiece W may be appropriately prevented during the first confirmation operation S11.

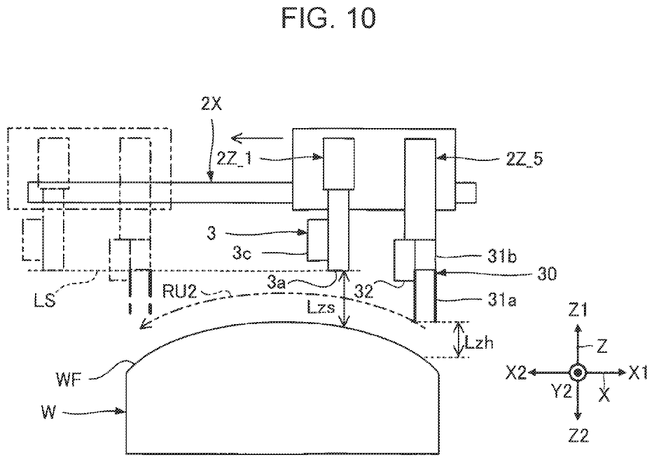

FIG. 10 is a diagram for describing the curing operation S30. Hereinafter, a change in positional relationship of the head unit 3 and the sensor unit 30 caused by the operations of the Z-axis movement mechanism 2Z_1 and the Z-axis movement mechanism 2Z_5 during the curing operation S30 will be representatively described with reference to FIG. 10. The matters described below also apply to changes in positional relationship of the head units 3 and the sensor unit 30 caused by the operations of the Z-axis movement mechanisms 2Z_2 to 2Z_4 and the Z-axis movement mechanism 2Z_5 during the curing operation S30.

FIG. 10 illustrates a case where the driving direction of the X-axis movement mechanism 2X during the curing operation S30 is the X2 direction. Here, in FIG. 10, a solid line indicates a state at the start of the curing operation S30, and a line with alternating long and two short dashes indicates a state at the end of the curing operation S30. The driving direction of the X-axis movement mechanism 2X during the curing operation S30 is not limited to the example illustrated in FIG. 10, and may be the X1 direction. However, since the driving direction of the X-axis movement mechanism 2X during the curing operation S30 is opposite to the driving direction of the X-axis movement mechanism 2X during the printing operation S20, transition from the printing operation S20 to the curing operation S30 can be quickly made.

As illustrated in FIG. 10, the position of the head 3a in the direction along the Z axis is constant over a period during which the curing operation S30 is being performed. In the example illustrated in FIG. 10, the head 3a moves along the straight line LS parallel to the X axis over the period during which the curing operation S30 is being performed. Here, as in the second confirmation operation S12, the head distance Lzh changes as the head 3a moves in the direction along the X axis.

On the other hand, the sensor distance Lzs is constant over the period during which the curing operation S30 is being performed. Accordingly, the position of the sensor 31 in the direction along the Z axis changes along the surface WF of the workpiece W during the curing operation S30. In the example illustrated in FIG. 10, the sensor 31 moves along a path RU2 over the period during which the curing operation S30 is being performed. The path RU2 may be the same as or different from the path RU based on the path information Da. The path RU2 may be positioned in the Z1 direction with respect to the path RU to prevent the contact between the sensor 31 and the workpiece W and irradiate the workpiece W with energy in a wide range. In the example illustrated in FIG. 10, the path RU2 has a shape along the surface WF, like the path RU. However, the path RU2 is not limited thereto and may be parallel to the X axis, for example.

As described above, the three-dimensional object printing apparatus 1 includes the head unit 3, the sensor unit 30, and the movement mechanism 2. The head unit 3 includes the head 3a that ejects the ink, which is an example of the “liquid”, along the Z axis toward the three-dimensional workpiece W. The sensor unit 30 includes the sensor 31 that detects a positional relationship with respect to the workpiece W. The movement mechanism 2 changes the positions of the head unit 3 and the sensor unit 30 with respect to the workpiece W.

In addition, the movement mechanism 2 includes the Z-axis movement mechanisms 2Z_1 to 2Z_4, which are examples of a “first movement mechanism”, and the Z-axis movement mechanism 2Z_5, which is an example of a “second movement mechanism”. Each of the Z-axis movement mechanisms 2Z_1 to 2Z_4 changes the position of each of the head units 3_1 to 3_4 with respect to the workpiece W along the Z axis, which is an example of a “first axis”. The Z-axis movement mechanism 2Z_5 changes the position of the sensor unit 30 with respect to the workpiece W along the Z axis. Moreover, the Z-axis movement mechanisms 2Z_1 to 2Z_4 and the Z-axis movement mechanism 2Z_5 move the head units 3_1 to 3_4 and the sensor unit 30 independently of each other.

In the three-dimensional object printing apparatus 1 described above, since the Z-axis movement mechanisms 2Z_1 to 2Z_4 and the Z-axis movement mechanism 2Z_5 move the head units 3_1 to 3_4 and the sensor unit 30 independently of each other, the sensor unit 30 can scan the workpiece W in a state in which the head unit 3 is retracted from the position at the time of printing with respect to the workpiece W. Therefore, the positional relationship with respect to the workpiece W can be detected using the sensor unit 30 while preventing the head 3a from colliding with the workpiece W. As a result, the followability of the head 3a to the workpiece W can be enhanced.

Further, the sensor unit 30 can be arranged in front of the head unit 3 in a scanning direction, and a distance between the sensor unit 30 and the workpiece W can be made equal to or shorter than a distance between the head 3a and the workpiece W. Therefore, even when an error occurs in the measurement of the distance between the workpiece W and the head 3a or the installation position of the workpiece W is misaligned, the sensor unit 30 can collide with the workpiece W before the head unit 3 collides with the workpiece W. Therefore, the contact between the head unit 3 and the workpiece W can be prevented by stopping the printing operation S20 when the sensor unit 30 collides with the workpiece W. Even when the sensor 31 collides with the workpiece W, replacement of the head 3a, supply of the ink due to the replacement, and alignment are not required. Therefore, even when the sensor 31 fails, the apparatus can be quickly repaired.

On the other hand, in a configuration in which the head unit 3 and the sensor unit 30 are attached to the same Z-axis movement mechanism 2Z, the positional relationship of the sensor 31 and the head 3a is fixed. In this case, since it is difficult to reduce the distance between the sensor 31 and the workpiece W when preventing the head 3a from colliding with the workpiece W, the measurement accuracy of the sensor 31 is lowered, and since it is difficult to reduce the distance between the head 3a and the workpiece W, image quality is lowered.

According to the present embodiment, as described above, the movement mechanism 2 further includes the X-axis movement mechanism 2X, which is an example of a “third movement mechanism”. The X-axis movement mechanism 2X changes the relative position of each of the head units 3_1 to 3_4 and the sensor unit 30 with respect to the workpiece W along the X axis orthogonal to the Z axis. Further, the three-dimensional object printing apparatus 1 performs the confirmation operation S10 and the printing operation S20. In the confirmation operation S10, the X-axis movement mechanism 2X is operated within a range in which each of the head 3a and the sensor 31 overlaps with the workpiece W when viewed in the direction along the Z axis in a state in which the head 3a does not eject the ink. The printing operation S20 is an operation performed after the confirmation operation S10, and in the printing operation S20, the X-axis movement mechanism 2X is operated within the range in which each of the head 3a and the sensor 31 overlaps with the workpiece W when viewed in the direction along the Z axis in a state in which the head 3a ejects the ink. Therefore, collision between the head 3a and the workpiece W may be appropriately prevented by performing the confirmation operation S12 before the printing operation S20.

According to the present embodiment, the confirmation operation S10 includes the first confirmation operation S11 and the second confirmation operation S12. Here, it can be said that each of the first confirmation operation S11 and the second confirmation operation S12 is an example of a “confirmation operation”. One of the first confirmation operation S11 and the second confirmation operation S12 may be omitted.

In addition, as described above, the three-dimensional object printing apparatus 1 further includes the movement control section 5b1 that controls the operations of the movement mechanism 2. The movement control section 5b1 controls the operation of each of the Z-axis movement mechanisms 2Z_1 to 2Z_4 and the Z-axis movement mechanism 2Z_5 in such a way that the average value of the head distances Lzh during the confirmation operation S10 is larger than the average value of the sensor distances Lzs during the confirmation operation S10. Therefore, collision between the head 3a and the workpiece Win the confirmation operation S10 can be prevented. The head distance Lzh is a distance between the head 3a and the workpiece W in the direction along the Z axis. The sensor distance Lzs is a distance between the sensor 31 and the workpiece W in the direction along the Z axis.

Further, as described above, the movement control section 5b1 controls the operation of each of the Z-axis movement mechanisms 2Z_1 to 2Z_4 and the Z-axis movement mechanism 2Z_5 in such a way that the amount of change in head distance Lzh during the confirmation operation S10 is larger than the amount of change in sensor distance Lzs during the confirmation operation S10. Therefore, it is possible to reduce the operation amounts of the Z-axis movement mechanisms 2Z_1 to 2Z_4 in the confirmation operation S10, and to suppress wear and power consumption of the members included in the Z-axis movement mechanisms 2Z_1 to 2Z_4.

Further, as described above, the movement control section 5b1 controls the operation of the Z-axis movement mechanism 2Z_5 in such a way that the average value of the head distances Lzh during the confirmation operation S10 is larger than the average value of the head distances Lzh during the printing operation S20. Therefore, collision between the head 3a and the workpiece W in the confirmation operation S10 can be prevented.

Further, as described above, the movement control section 5b1 controls the operation of the Z-axis movement mechanism 2Z_5 in such a way that the amount of change in head distance Lzh during the confirmation operation S10 is larger than the amount of change in head distance Lzh during the printing operation S20. Therefore, it is possible to reduce the operation amounts of the Z-axis movement mechanisms 2Z_1 to 2Z_4 in the confirmation operation S10, and to suppress wear and power consumption of the members included in the Z-axis movement mechanisms 2Z_1 to 2Z_4.

Further, as described above, the movement control section 5b1 controls the operation of each of the Z-axis movement mechanisms 2Z_1 to 2Z_4 and the Z-axis movement mechanism 2Z_5 in such a way that the average value of the sensor distances Lzs during the printing operation S20 is substantially the same as the average value of the head distances Lzh during the printing operation S20. Therefore, it is possible to perform scanning to follow the surface of the workpiece W along the same path in a state where the sensor 31 is positioned in front of the head 3a.

Further, as described above, the movement control section 5b1 controls the operation of each of the Z-axis movement mechanisms 2Z_1 to 2Z_4 and the Z-axis movement mechanism 2Z_5 in such a way that the average value of the sensor distances Lzs during the confirmation operation S10 (especially during the first confirmation operation S11 in the present embodiment) is larger than the average value of the sensor distances Lzs during the printing operation S20. Therefore, collision between the head 3a and the workpiece W in the confirmation operation S10 can be prevented. In particular, in the initially performed confirmation operation S10, detailed information regarding the shape of the workpiece W may not be obtained, and thus, collision between the sensor 31 and the workpiece W can be appropriately prevented by increasing the sensor distance Lzs.

Further, as described above, the movement control section 5b1 controls the operation of the Z-axis movement mechanism 2Z_5 in such a way that the operation amount of the Z-axis movement mechanism 2Z_5 during the first confirmation operation S11 is smaller than the operation amount of the Z-axis movement mechanism 2Z_5 during the printing operation S20, and the average value of the sensor distances Lzs during the first confirmation operation S11 is larger than the average value of the sensor distances Lzs during the printing operation S20. Therefore, it is possible to reduce the operation amount of the Z-axis movement mechanism 2Z_5 in the first confirmation operation S11, and to suppress wear and power consumption of the members included in the Z-axis movement mechanism 2Z_5. As a result, when the sensor 31 includes the distance sensor 31b, the shape of the workpiece W can be easily measured based on a detection result of the distance sensor 31b in the first confirmation operation S11. Further, the collision between the sensor 31 and the workpiece W can be appropriately prevented.

In addition, the sensor 31 includes the contact sensors 31a that detect the contact with the workpiece W as described above. Therefore, the collision between the head 3a and the workpiece W can be appropriately prevented.

Furthermore, the sensor 31 further includes the distance sensor 31b that detects a distance to the workpiece W as described above. Therefore, it is possible to generate information regarding a movement path of the head 3a based on a detection result of the distance sensor 31b.

Further, as described above, the head 3a has the nozzle surface FN in which the nozzles N that eject the ink are formed. The contact sensors 31a have the plurality of distal ends ES that define the distal end region RE. The outer shape of the distal end region RE is substantially the same as the outer shape of the nozzle surface FN. Therefore, it is possible to reproduce the arrangement of the head 3a during the printing operation S20 by using the sensor 31. As a result, collision between the head 3a and the workpiece W can be appropriately prevented based on a detection result of the sensor 31. In addition, the contact sensors 31a are not limited to having the plurality of distal ends ES, and may have a distal end surface whose outer shape is substantially the same as the outer shape of the nozzle surface FN, for example. Therefore, it is possible to reproduce the arrangement of the head 3a during the printing operation S20 by using the sensor 31 as described above.

Furthermore, as described above, the sensor unit 30 further includes the energy emission section 32 that emits light that cures or solidifies the ink on the workpiece W. Therefore, by driving the Z-axis movement mechanism 2Z_5, the position of the energy emission section 32 with respect to the workpiece W can be changed independently of the head unit 3 along the Z axis. Accordingly, it is possible to cure or solidify the ink, which is an example of the “liquid”, on the workpiece W with the energy from the energy emission section 32 while preventing collision between the head 3a and the workpiece W.

### 2. SECOND EMBODIMENT

Hereinafter, a second embodiment of the present disclosure will be described. The reference numerals used in the description of the first embodiment are used for the elements having the same actions and functions as those of the first embodiment in the embodiment exemplified below, and a detailed description of each element is appropriately omitted.

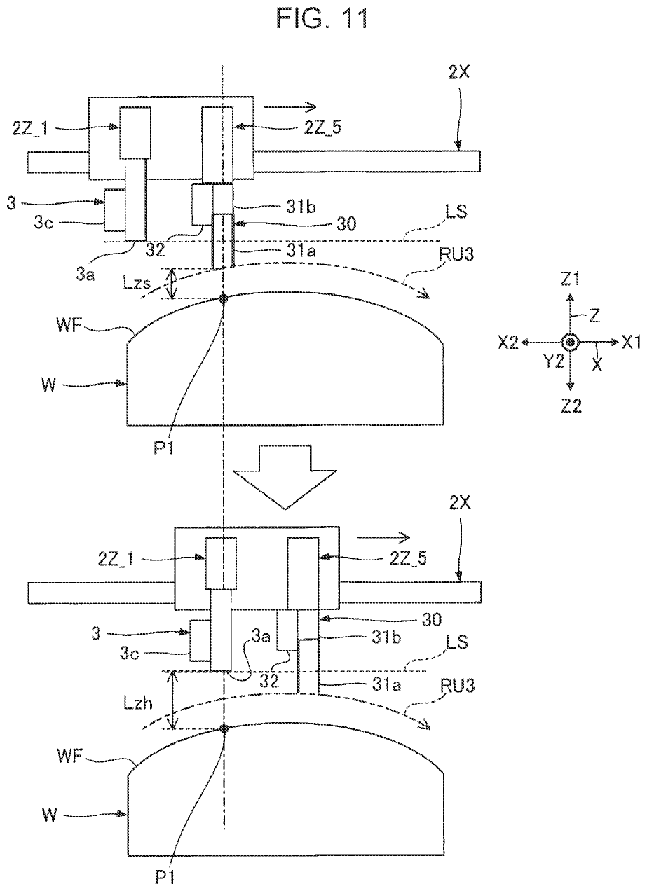

FIG. 11 is a diagram for describing a confirmation operation S10 according to the second embodiment. In FIG. 11, among a plurality of Z-axis movement mechanisms 2Z supported on an X-axis movement mechanism 2X, a Z-axis movement mechanism 2Z_1 and a Z-axis movement mechanism 2Z_5 are representatively illustrated for convenience of explanation. FIG. 11 illustrates a case where a driving direction of the X-axis movement mechanism 2X during the confirmation operation S10 is the X1 direction. Here, in FIG. 11, the upper part shows a state in which the position of a sensor unit 30 in the direction along the X axis is a position P1, and the lower part shows a state in which the position of a head unit 3 in the direction along the X axis is the position P1.

The present embodiment is the same as the first embodiment described above, except that the confirmation operation S10 is different. The confirmation operation S10 of the present embodiment is performed instead of the confirmation operation S10 or the second confirmation operation S12 of the first embodiment. The confirmation operation S10 of the present embodiment may be performed in addition to the confirmation operation S10 of the first embodiment. In this case, the confirmation operation S10 of the present embodiment may be performed between the first confirmation operation S11 and the second confirmation operation S12 of the first embodiment.

The confirmation operation S10 of the present embodiment is the same as the second confirmation operation S12 of the first embodiment, except that an average value of sensor distances Lzs during the confirmation operation S10 is larger than an average value of sensor distances Lzs during the printing operation S20. In the example illustrated in FIG. 11, a sensor 31 moves along a path RU3 over a period during which the confirmation operation S10 is being performed. The path RU3 has a shape along a path RU based on path information Da and is positioned in the Z1 direction with respect to the path RU.

Contact between a head 3a and the workpiece W can be reduced also by the above-described second embodiment. According to the present embodiment, as described above, a movement control section 5b1 controls an operation of each of the Z-axis movement mechanisms 2Z_1 to 2Z_4 and the Z-axis movement mechanism 2Z_5 in such a way that an average value of sensor distances Lzs during the confirmation operation S10 is larger than an average value of sensor distances Lzs during the printing operation S20. Therefore, collision between the head 3a and the workpiece W in the confirmation operation S10 can be prevented. In particular, in the initially performed confirmation operation S10, detailed information regarding the shape of the workpiece W may not be obtained, and thus, collision between the sensor 31 and the workpiece W can be prevented by increasing the sensor distance Lzs.

### 3. THIRD EMBODIMENT

Hereinafter, a third embodiment of the present disclosure will be described. The reference numerals used in the description of the first embodiment are used for the elements having the same actions and functions as those of the first embodiment in the embodiment exemplified below, and a detailed description of each element is appropriately omitted.

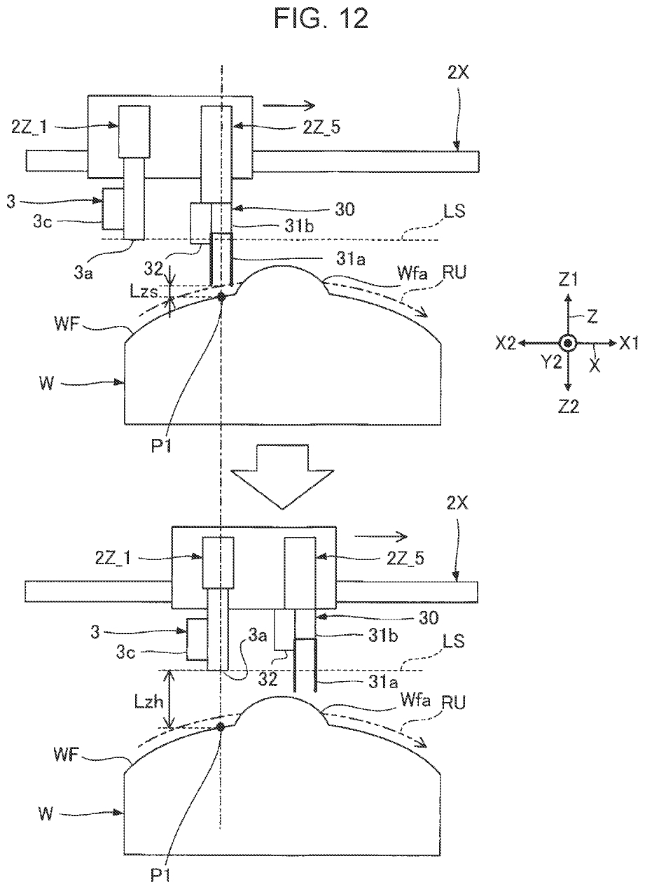

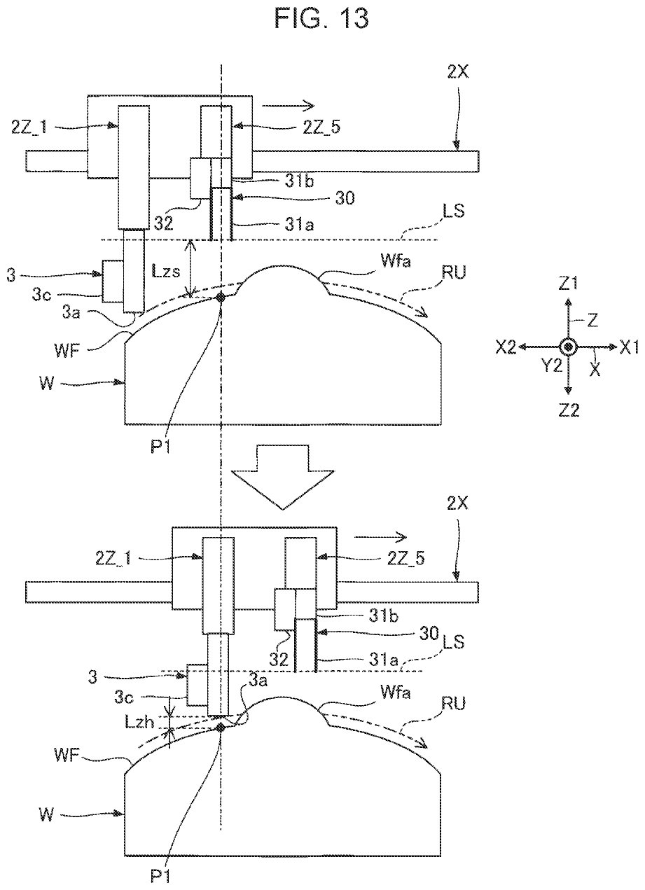

FIG. 12 is a diagram for describing a confirmation operation S10 according to the third embodiment. FIG. 13 is a diagram for describing a printing operation S20 according to the third embodiment. In FIGS. 12 and 13, among a plurality of Z-axis movement mechanisms 2Z supported on an X-axis movement mechanism 2X, a Z-axis movement mechanism 2Z_1 and a Z-axis movement mechanism 2Z_5 are representatively illustrated for convenience of explanation. FIGS. 12 and 13 illustrate a case where a driving direction of the X-axis movement mechanism 2X during the confirmation operation S10 is the X1 direction. Here, in FIGS. 12 and 13, the upper parts show a state in which the position of a sensor unit 30 in the direction along the X axis is a position P1, and the lower parts show a state in which the position of a head unit 3 in the direction along the X axis is the position P1.

The present embodiment is the same as the first embodiment described above, except that the shape of a workpiece W and the printing operation S20 are different. In the present embodiment, as illustrated in FIG. 12, a convex portion WFa is formed on a surface WF of the workpiece W. The confirmation operation S10 of the present embodiment is the same as the second confirmation operation S12 of the first embodiment.

The printing operation S20 of the present embodiment is the same as the printing operation S20 of the first embodiment, except that an average value of sensor distances Lzs during the printing operation S20 is larger than an average value of sensor distances Lzs during the confirmation operation S10. Therefore, according to the present embodiment, the average value of the sensor distances Lzs during the confirmation operation S10 is smaller than the average value of the sensor distances Lzs during the printing operation S20.

Contact between a head 3a and the workpiece W can be reduced also by the above-described third embodiment. According to the present embodiment, as described above, a movement control section 5b1 controls an operation of the Z-axis movement mechanism 2Z_5 in such a way that the average value of the sensor distances Lzs during the confirmation operation S10 is smaller than the average value of the sensor distances Lzs during the printing operation S20. Therefore, collision between a sensor 31 and the workpiece W in the printing operation S20 can be prevented.

### 4. MODIFIED EXAMPLES

Each embodiment can be modified in the above-described example. Specific modified aspects that can be applied to each embodiment described above are described below by way of example. Note that two or more aspects arbitrarily selected from the following examples can be appropriately and compatibly combined.

### 4-1. Modified Example 1

In the above-described embodiments, the workpiece W is moved in the direction along the Y axis. However, the present disclosure is not limited thereto, and for example, the Y-axis movement mechanism 4Y of the support mechanism 4 may be omitted. In this case, the movement mechanism 2 may include a mechanism for moving the head units 3 and the sensor unit 30 in the direction along the Y axis.

### 4-2. Modified Example 2

In the above-described embodiments, the movement mechanism 2 includes the X-axis movement mechanism 2X. However, the present disclosure is not limited thereto, and the X-axis movement mechanism 2X may be omitted. In this case, the support mechanism 4 may include a mechanism for moving the workpiece W in the direction along the X axis.

### 4-3. Modified Example 3

In the above-described embodiments, the three-dimensional object printing apparatus 1 includes four head units 3_1 to 3_4. However, the present disclosure is not limited thereto, and the number of head units 3 included in the three-dimensional object printing apparatus 1 may be one or more and three or less or may be five or more. Here, when the three-dimensional object printing apparatus 1 includes a plurality of head units 3, it is sufficient that the number of head units 3 that move in the direction along the Z axis by the first Z-axis movement mechanism be one or more. The plurality of head units 3 may include a head unit 3 that does not move in the direction along the Z axis. That is, it is sufficient that the number of first Z-axis movement mechanisms included in the three-dimensional object printing apparatus 1 be one or more.

### 4-4. Modified Example 4

In the above-described embodiments, the curing operation S30 is performed, but the present disclosure is not limited thereto, and the curing operation S30 may be omitted. In this case, the energy emission section 3c may completely cure the ink on the workpiece W, for example.

### 4-5. Modified Example 5

In the above-described embodiments, the movement mechanism 2 changes the positions of the head unit 3 and the sensor unit 30. However, the present disclosure is not limited thereto, and the movement mechanism 2 may change the positions and postures of the head unit 3 and the sensor unit 30. For example, the movement mechanism 2 may be a vertical multi-axis robot or a horizontal multi-axis robot.

### 4-6. Modified Example 6

In the above-described embodiments, printing is performed by using one type of ink. However, the present disclosure is not limited thereto and can also be applied to a configuration in which printing is performed by using two or more types of ink.

### 4-7. Modified Example 7

The use of the three-dimensional object printing apparatus according to the present disclosure is not limited to printing. For example, the three-dimensional object printing apparatus that ejects a solution of a coloring material is used as a producing apparatus that forms a color filter of a liquid crystal display apparatus. Further, the three-dimensional object printing apparatus that ejects a solution of a conductive material is used as a producing apparatus that forms a wiring or electrode of a wiring substrate. The three-dimensional object printing apparatus can also be used as a jet dispenser that applies a liquid such as an adhesive to a medium.

What is claimed is:

1. A three-dimensional object printing apparatus comprising:
a head unit including a head that ejects a liquid toward a workpiece along a first axis;
a sensor unit including a sensor that detects a positional relationship with respect to the workpiece; and
a movement mechanism that changes positions of the head unit and the sensor unit with respect to the workpiece, wherein
the movement mechanism includes a first movement mechanism that changes the position of the sensor unit with respect to the workpiece along the first axis, and a second movement mechanism that changes the position of the head unit with respect to the workpiece along the first axis, and
the first movement mechanism and the second movement mechanism move the sensor unit and the head unit independently of each other.

2. The three-dimensional object printing apparatus according to claim 1, further comprising a movement control section that controls the movement mechanism, wherein
the movement mechanism further includes a third movement mechanism that changes a relative position of each of the head unit and the sensor unit with respect to the workpiece along a second axis orthogonal to the first axis, and
the movement control section performs a confirmation operation and a printing operation, the confirmation operation being an operation in which the third movement mechanism is operated within a range in which each of the head and the sensor overlaps with the workpiece when viewed in a direction along the first axis in a state in which the head does not eject the liquid, and the printing operation being an operation which is performed after the confirmation operation and in which the third movement mechanism is operated within a range in which each of the head and the sensor overlaps with the workpiece when viewed in the direction along the first axis in a state in which the head ejects the liquid.

3. The three-dimensional object printing apparatus according to claim 2, wherein
when a distance between the head and the workpiece in the direction along the first axis is a head distance, and a distance between the sensor and the workpiece in the direction along the first axis is a sensor distance, the movement control section controls the first movement mechanism and the second movement mechanism in such a way that an average value of the head distances during the confirmation operation is larger than an average value of the sensor distances during the confirmation operation.

4. The three-dimensional object printing apparatus according to claim 3, wherein
the movement control section controls the first movement mechanism and the second movement mechanism in such a way that an amount of change in head distance during the confirmation operation is larger than an amount of change in sensor distance during the confirmation operation.

5. The three-dimensional object printing apparatus according to claim 2, wherein
when a distance between the head and the workpiece in the direction along the first axis is a head distance, the movement control section controls the second movement mechanism in such a way that an average value of the head distances during the confirmation operation is larger than an average value of the head distances during the printing operation.

6. The three-dimensional object printing apparatus according to claim 5, wherein
the movement control section controls the second movement mechanism in such a way that an amount of change in head distance during the confirmation operation is larger than an amount of change in head distance during the printing operation.

7. The three-dimensional object printing apparatus according to claim 3, wherein
when the distance between the sensor and the workpiece in the direction along the first axis is the sensor distance, the movement control section controls the first movement mechanism and the second movement mechanism in such a way that an average value of the sensor distances during the printing operation is substantially the same as an average value of the head distances during the printing operation.

8. The three-dimensional object printing apparatus according to claim 3, wherein
when the distance between the sensor and the workpiece in the direction along the first axis is the sensor distance, the movement control section controls the first movement mechanism and the second movement mechanism in such a way that the average value of the sensor distances during the confirmation operation is larger than an average value of the sensor distances during the printing operation.

9. The three-dimensional object printing apparatus according to claim 5, wherein
when a distance between the sensor and the workpiece in the direction along the first axis is a sensor distance, the movement control section controls the second movement mechanism in such a way that an average value of the sensor distances during the confirmation operation is smaller than an average value of the sensor distances during the printing operation.

10. The three-dimensional object printing apparatus according to claim 5, wherein
when a distance between the sensor and the workpiece in the direction along the first axis is a sensor distance, the movement control section controls the second movement mechanism in such a way that an operation amount of the second movement mechanism during the confirmation operation is smaller than an operation amount of the second movement mechanism during the printing operation, and an average value of the sensor distances during the confirmation operation is larger than an average value of the sensor distances during the printing operation.

11. The three-dimensional object printing apparatus according to claim 1, wherein
the sensor includes a contact sensor that detects contact with the workpiece.

12. The three-dimensional object printing apparatus according to claim 11, wherein
the sensor further includes a distance sensor that detects a distance to the workpiece.

13. The three-dimensional object printing apparatus according to claim 11, wherein
the head has a nozzle surface in which nozzles that eject the liquid are formed,
the contact sensors have a distal end surface or a plurality of distal ends that define a distal end region, and
an outer shape of the distal end surface or the distal end region is substantially the same as an outer shape of the nozzle surface.

14. The three-dimensional object printing apparatus according to claim 1, wherein
the sensor unit further includes an energy emission section that emits light that cures or solidifies the liquid on the workpiece.

15. A control method for controlling a three-dimensional object printing apparatus including a head unit including a head that ejects a liquid toward a workpiece along a first axis, a sensor unit including a sensor that detects a positional relationship with respect to the workpiece, a first movement mechanism that changes a position of the sensor unit with respect to the workpiece along the first axis, and a second movement mechanism that changes a position of the head unit with respect to the workpiece along the first axis, the control method comprising:
moving, by the first movement mechanism and the second movement mechanism, the sensor unit and the head unit independently of each other.

16. The control method, according to claim 15, for controlling the three-dimensional object printing apparatus further including a third movement mechanism that changes a relative position of each of the head unit and the sensor unit with respect to the workpiece along a second axis orthogonal to the first axis, further comprising:
a confirmation operation in which the third movement mechanism is operated within a range in which each of the head and the sensor overlaps with the workpiece when viewed in a direction along the first axis in a state in which the head does not eject the liquid, and
a printing operation in which the third movement mechanism is operated within a range in which each of the head and the sensor overlaps with the workpiece when viewed in the direction along the first axis in a state in which the head ejects the liquid.
